(19) United States
(12) Patent Application Publication
(10) Pub. No.: US 2009/0231138 A1
(43) Pub. Date: Sep. 17, 2009

(54) RFID Technology

(75) Inventors: Kin Yue Albert LAI, Hong Kong (HK); Siu Chong TIN, Hong Kong (HK); On Yung Timmy WONG, Hong Kong (HK); Chi Chiu CHEUNG, Hong Kong (HK)

Correspondence Address: WILLIAM J. SAPONE;COLEMAN SUDOL SAPONE P.C., 714 COLORADO AVENUE, BRIDGE PORT, CT, 06605, US

(73) Assignee: CHUNG NAM ELECTRONICS CO. LTD., Hong Kong (HK)

(21) Appl. No.: 12/048,842

(22) Filed: Mar. 14, 2008

(51) Int. Cl. H04Q 5/22; G08B 13/14

(52) U.S. Cl. 340/572.4; 340/10.33; 340/572.1; 340/10.1

(57) ABSTRACT

A method of selectively waking up a plurality of RFID tags includes (a) providing a first RFID tag; (b) programming the first RFID tag to respond and wake up only to signals at a first sub-carrier frequency or with a first code; (c) providing a second RFID tag; and (d) programming the second RFID tag to respond and wake up only to signals at a second sub-carrier frequency or with a second code. A method of operating an RFID tag positioning system includes (a) positioning two real time location tracking active RFID readers in two respective locations; (b) positioning a first calibrating RFID tag at a fixed and known position; (c) moving a second calibrating RFID tag along a pre-determined path; (d) obtaining the first RFID reader's readings of location-related information of the RFID tags at a point in time; (e) obtaining the second RFID reader's readings of location-related information of the RFID tags at that point in time; and (f) comparing the readings with the known positions of the first and second calibrating tags.

This invention relates to various improvements in and relating to RFID (radio-frequency identification) technology.

### BACKGROUND OF THE INVENTION

Radio-frequency identification (RFID) is an automatic identification method, relying on storing and remotely retrieving data using devices called RFID tags or transponders. An RFID tag is an object that can be applied to or incorporated into a product, animal or person for the purpose of identification using radio waves. Most RFID tags contain at least two parts, namely (a) an integrated circuit (IC) for storing and processing information, modulating and demodulating a radio-frequency (RF) signal, which may also be used for other specialized functions, and (b) an antenna for receiving and transmitting the signal.

In recent years, there have been significant developments in the field of RFID technology. However, there still exist various shortcomings associated with the present RFID tags and RFID readers. For example, a batch of goods are in transit and all such goods are associated with RFID tags which are in sleeping mode in transit. A user may then wish to wake up certain RFID tags associated with a certain kind of such goods but not others. Conventionally, the user would have no choice but to transmit a wakeup beacon onto the batch of goods, and wake up all RFID tags. The available energy of some of the RFID tags is thus wasted, and thus their usable life is shortened.

In addition, an object embedded, implanted or inserted with one type of RFID tag will only respond to queries from one type of RFID reader, which is not versatile in use.

These are just some examples of the existing shortcomings of the existing RFID technology. It is thus an object of the present invention to provide various improvements in and relating to RFID technology with a view to mitigating the present shortcomings associated with the RFID technology, or to at least provide useful alternatives to the public

### SUMMARY OF THE INVENTION

According to a first aspect of this invention, there is provided a method of selectively waking up at least two RFID tags, including steps of (a) providing a first RFID tag: (b) programming said first RFID tag to respond to and wake up only to signals with a first characteristic; (c) providing a second RFID tag; and (d) programming said second RFID tag to respond to and wake up to only to signals with a second characteristic.

According to a second aspect of the present invention, there is provided a dual-mode active RFID tag, wherein said tag is adapted to be in a real time location system (RTLS) mode for a first pre-determined period of time and in an inventory mode for a second pre-determined period of time.

According to a third aspect of the present invention, there is provided a signal transmission apparatus for transmitting wakeup signals to RFID tags, said apparatus being adapted to transmit signals with information indicative of the cumulative period of time which has lapsed since transmission of the first wakeup signal.

According to a fourth aspect of the present invention, there is provided a method of transmitting wakeup signals to RFID tags, including transmitting signals with information indicative of the cumulative period of time which has lapsed since transmission of the first wakeup signal.

According to a fifth aspect of the present invention, there is provided an RFID tag assembly with at least an active RFID tag and at least a passive RFID tag.

According to a sixth aspect of the present invention, there is provided a portable RFID reader containing a real time location tracking RFID tag.

According to a seventh aspect of the present invention, there is provided a portable RFID reader containing a global positioning system (GPS) receiver.

According to an eighth aspect of the present invention, there is provided an active RFID tag with at least two electric power sources, wherein at least one of said electric power sources is rechargeable.

According to a ninth aspect of the present invention, there is provided an active RFID tag reader with at least two electric power sources, wherein at least one of said electric power sources is rechargeable.

According to a tenth aspect of the present invention, there is provided a method of calibrating an RFID tag positioning system with at least a first and a second real time location tracking active RFID readers, including the steps of (a) positioning said at least two real time location tracking active RFID readers in two respective locations in an environment; (b) positioning a first calibrating RFID tag at a fixed and known position in said environment; (c) moving a second calibrating RFID tag along a pre-determined path in said environment; (d) obtaining said first RFID reader's readings of location-related information of said first and second calibrating RFID tags at a point in time; (e) obtaining said second RFID reader's readings of location-related information of said first and second calibrating RFID tags at said point in time; and (f) comparing said readings of said first RFID reader and of said second RFID reader with said known positions of said first and second calibrating tags.

According to an eleventh aspect of the present invention, there is provided an RFID tag including an RFID tag integrated circuit; a high dielectric constant plastic layer with two major surfaces; a first layer of printed-circuit-board material fixedly secured on a first major surface of said plastic layer; a second layer of printed-circuit-board material fixedly secured on a second major surface of said plastic layer; and antenna formed on said first layer of printed-circuit-board material.

According to a twelfth aspect of the present invention, there is provided an RFID reader including a high dielectric constant plastic layer with two major surfaces; a first layer of printed-circuit-board material fixedly secured on a first major surface of said plastic layer; a second layer of printed-circuit-board material fixedly secured on a second major surface of said plastic layer; and an antenna formed on said first layer of printed-circuit-board material.

According to a thirteenth aspect of the present invention, there is provided an RFID system including a remote controller of an electrical appliance, said remote controller having at least one RFID reader adapted to receive at least identity (ID) data from at least one RFID tag; a data processing apparatus adapted to receive at least said ID data from said remote controller; and a visual display unit adapted to visually show at least said ID data of said RFID tag.

### BRIEF DESCRIPTION OF THE DRAWINGS

Preferred embodiments of the present invention will now be described, by way of example only, with reference to the accompanying drawings, in which:

FIG. 1 is graph showing the multi-subcarrier wakeup concept according to an aspect of the present invention;

FIG. 2 are graphs showing the multi-code wakeup concept according to a further aspect of the present invention;

FIG. 3 is a flow chart showing the modes which a dual-mode active RFID tag according to a yet further aspect of the present invention may be in;

FIG. 4 is a graph showing schematically a pattern of signals of a wakeup beacon of a method of transmitting wakeup signals to RFID tags according to a still further aspect of the present invention;

FIG. 5 is a schematic view of an RFID tag with both an active RFID tag module and a passive RFID tag module according to an aspect of this invention,

FIG. 6 shows further capabilities of the RFID tag shown in FIG. 5;

FIG. 7 shows a schematic circuit arrangement of the RFID tag of FIG. 5;

FIG. 8 shows interaction of the circuit arrangement of FIG. 7 with queries from an active RFID reader;

FIG. 9 shows further capabilities of the circuit arrangement of FIG. 7;

FIG. 10 shows schematically a portable RFID reader with a real time location (RTLS) RFID tag, according to a further aspect of the present invention:

FIG. 11 shows schematically a portable RFID reader with a global positioning system (GPS) receiver, according to a still further aspect of the present invention;

FIG. 12 shows schematically a portable RFID reader with both an real time location (RTLS) RFID tag and a global positioning system (GPS) receiver, according to a yet further aspect of the present invention;

FIG. 13 shows schematically an active RFID tag with energy harvesting system and multiple battery banks, according to an aspect of the present invention;

FIG. 14 shows schematically an active RFID reader with energy harvesting system and multiple battery banks, according to a further aspect of the present invention;

FIG. 15 shows schematically the arrangement for calibrating a plurality of RTLS RFID readers in an environment, according to a still further aspect of the present invention;

FIG. 16 shows the structure of an RFID reader antenna according to a yet further aspect of the present invention;

FIG. 17 shows schematically the arrangement of an RFID system according to an aspect of the present invention;

FIG. 18 shows a variant arrangement to the RFID system shown in FIG. 17;

FIG. 19 shows a further variant arrangement to the RFID system shown in FIG. 17;

FIG. 20 shows a still further variant arrangement to the RFID system shown in FIG. 17;

FIG. 21 shows a yet further variant arrangement to the RFID system shown in FIG. 17.

### DETAILED DESCRIPTION OF THE PREFERRED EMBODIMENTS

A first aspect of this invention relates to ways of selectively waking up certain of a number of RFID tags but not others. Take as an example the situation with two RFID tags, say Tag A₁ and Tag A₂. Tag A₁ is embedded, implanted or inserted in an Object O₁, and Tag A₂ is embedded, implanted or inserted in an Object O₂, which is transported together with Object O₁, say in a same truck. Both Tag A₁ and Tag A₂. are in sleeping mode, and it is now desired to identify whether the truck contains Object O₁ In the conventional method, a wakeup beacon is transmitted into the truck, and wake' up both Tag A₁ and Tag A₂, thus wasting the energy stored in Tag A₂.

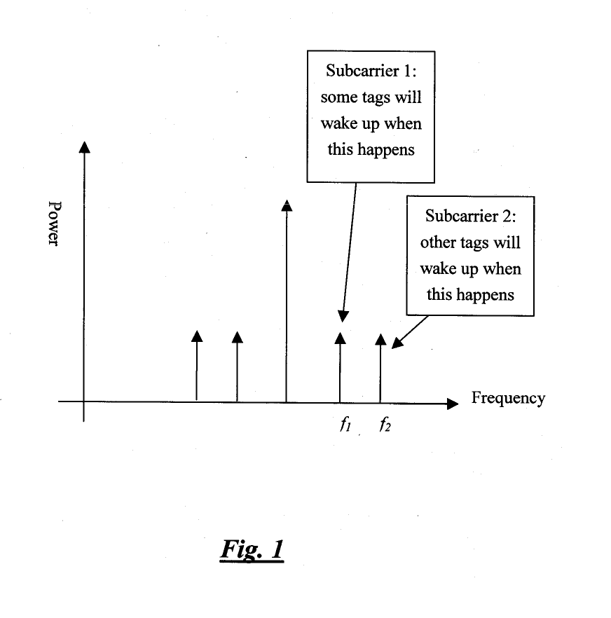

The underlying concept of the new scheme is to program the RFID tags differently, so that they respond to and wakeup to wakeup signals with different characteristics. FIG. 1 shows a multi-subcarrier wakeup scheme according to an aspect of the present invention. In this multi-subcarrier wakeup scheme, selective wakeup of RFID tags can be achieved. A subcarrier is a separate analogue or digital signal carried on a main radio transmission.

An RFID reader is constructed to be capable of wirelessly transmitting wakeup signals/messages at different frequency subcarriers, and that the relevant RFID tags are programmed to respond to and wake up only to wakeup signals with different subcarriers. For example, and a shown in FIG. 1, the RFID reader is capable of selectively wirelessly transmitting wakeup signals/messages with subcarrier 1 at f₁ and with subcarrier at f₂. Again take the example of two RFID tags, Tag B₁ and Tag B₂. Tag B₁ is software configured to respond to and wake up only to wakeup signals/messages transmitted with a subcarrier at a frequency of f₁, and Tag B₂ is software configured to respond to and wake up only to wakeup signals/messages transmitted with a subcarrier at a frequency of f₂.

Thus, it is possible to selectively waking up Tag B₁ (without simultaneously waking up Tag B₂) by operating the RFID reader to wirelessly transmit wakeup signals/messages with a subcarrier at frequency f₁. Such an arrangement allows partitioning of the RFID tags without having to wake up all RFID tags in response to all wakeup calls to wait for summoning, and the energy stored in Tag B₂ is thus not wasted.

It is envisaged that the RFID tags may be re-configured so as to allow more convenience and versatility in use. For example, after Tag B₁ and Tag B₂ have moved from one zone to another zone (be it the logistics trail waypoint or work-in-progress stage), where it is no longer necessary to differentiate these two tags vis-á-vis their response to wakeup calls, Tag B₂ may be re-configured to respond to wakeup signals/messages transmitted with a subcarrier at a frequency of fₗ (as is Tag B₁), or to any wakeup calls.

It is also possible to software configure Tag B₁ such that it responds to and wakes up only to wakeup signals/messages transmitted with a subcarrier at a frequency of f₁ for a pre-determined period of time T₁, after which it will charge to respond to and wake up only to wakeup signals/messages transmitted with a subcarrier at a frequency of f₂ for a determined period of time T₂, after which it will change to respond to and wake up only to wakeup signals/messages transmitted with a subcarrier at a frequency of f₃ for a determined period of time T₃, and so on. All these periods of time T₁, T₂ and T₃ are configurable and field-programmable and re-configurable.

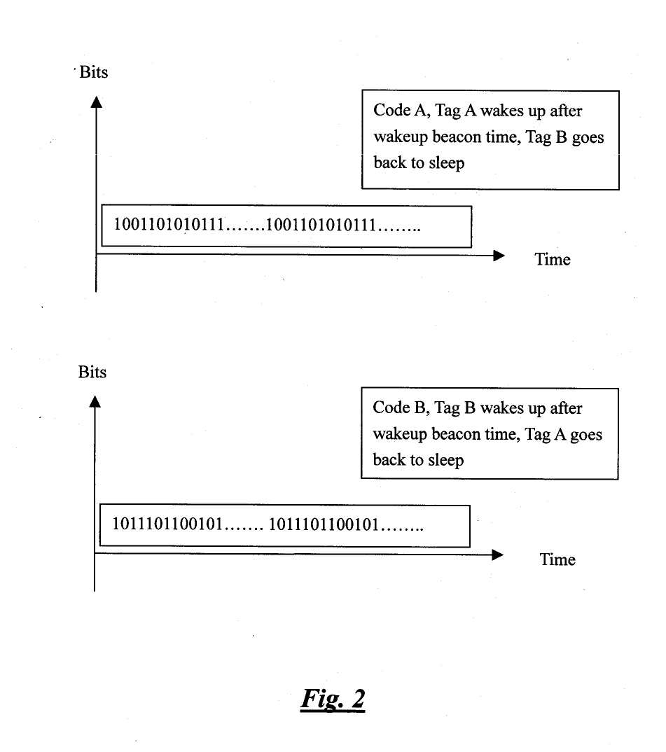

A second possible scheme allowing selective waking up of RFID tags is a multi-code scheme as shown in the two graphs of FIG. 2. In this multi-code scheme, an RFID reader is constructed to be capable of wirelessly transmitting wakeup signals/messages with different codes, and that the relevant RFID tags are programmed to respond to and wake up only to wakeup signals with different codes. For example, and as shown in FIG. 2, the RFID reader is capable of selectively wirelessly transmitting wakeup signals/messages with Code A and with Code B. Take the example of two RFID tags, Tag C₁ and Tag C₂. Tag C₁ is software configured to respond to and wake up only to wakeup signals/messages transmitted with Code A, and Tag C₂ is software configured to respond to and wake up only to wakeup signals/messages transmitted with Code B. It can be seen that, as in the case of the multi-subcarrier scheme discussed above, it is possible to selectively wake up Tag C₁ and not Tag C₂, or vice versa.

Similarly, it is possible to re-configure Tag C₁ so that after it has moved from one zone to another zone, it will respond to wakeup signals/messages transmitted with Code B, or to any wakeup calls. It is also possible to software configure Tag C₁ such that it responds to and wakes up only to wakeup signals/messages transmitted with Code A for a determined period of time T₄, after which it will change to respond to and wake up only to wakeup signals/messages transmitted with Code B for a determined period of time T₅, after which it will change to respond to and wake up only to wakeup signals/messages transmitted with Code C for a determined period of time T₆, and so on. All these periods of time T₄, T₅ and T₆ are configurable and field-programmable and re-configurable.

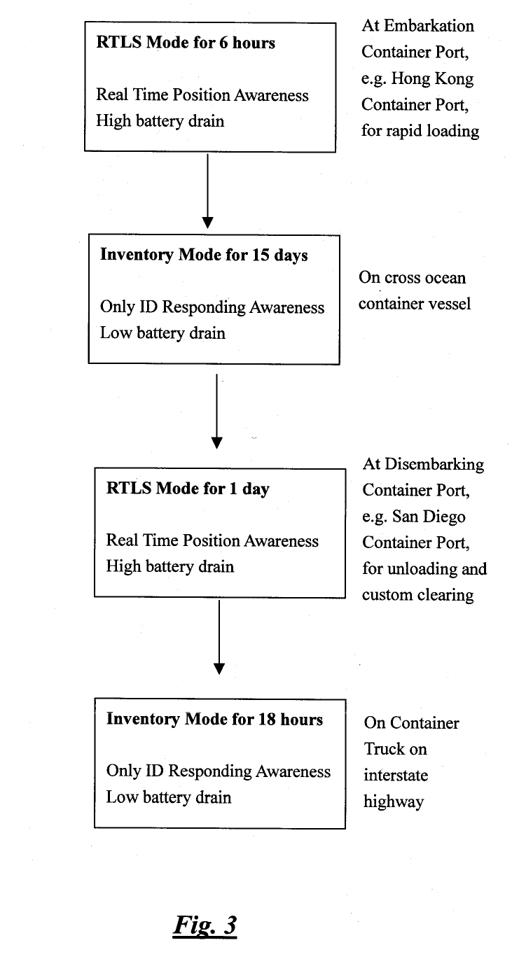

According to a further aspect of the present invention, a dual-mode active RFID tag is provided, which may operate either in a real time location system (RTLS) mode or an inventory mode. As shown in the flow chart of FIG. 3, which shows an exemplary sequence of mode states of a dual-mode active RFID tag according to this aspect of the invention. As shown in FIG. 3, such a dual-mode active RFID tag may be software configured to be in one of the RTLS mode or inventory mode in the following order:

remains in RTLS mode for six hours, in which the tag is of real time position awareness, with high battery drain. When queried by an RFD reader, the tag will provide real time data of its location. This is required when the RFID tag (as well as the article with which the tag is associated) is at an embarkation container port (e.g. Hong Kong Container Port) for rapid loading;

then remains in inventory mode for fifteen days, in which the RFID tag is only of ID responding awareness, with low battery drain. When queried by an RFID reader, the tag will only provide data showing its own identity. This may be the time duration for which the tag (as well as the article with which the tag is associated) is on a cross-ocean container vessel;

then remains in RTLS mode for one day, in which the tag is of real time position awareness, with high battery drain. When queried by an RFID reader, the tag will provide real time data showing its location. This is required when the tag (as well as the article with which the tag is associated) is at an disembarking container port (e.g. San Diego Container Port) for unloading and custom clearing; and

then remains in inventory mode for eighteen hours, in which the RFID tag is only of ID responding awareness, with low battery drain, when the tag (as well as the article with which the tag is associated) is in a container truck on an interstate highway. When queried by an RFID reader, the tag will only provide data showing its own identity.

It can be seen that the RFID tag may alternate between RTLS mode and inventory mode to suit different needs and environments.

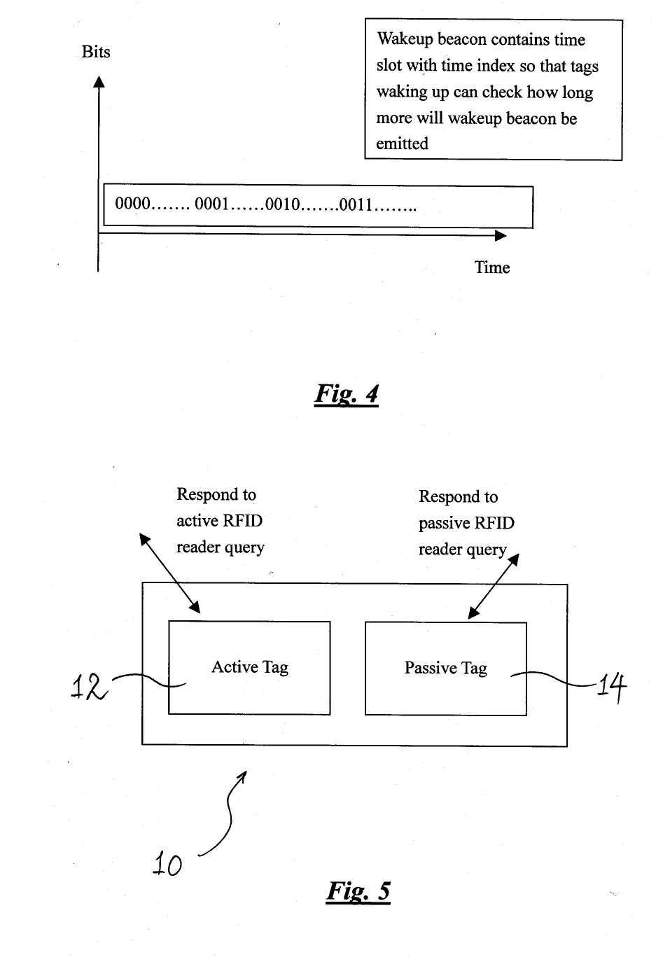

With such a dual-mode active RFID tag, a signal transmission apparatus is constructed to wirelessly transmit wakeup beacon/signals with time information of the cumulative period of time which has elapsed since transmission of the first wakeup signal up till the then current moment. As shown in FIG. 4, the wakeup beacon contains time slots with time index. This is useful in cases where a tag is software configured to Remain in sleeping mode for a long time. The RFID tag can calculate, on the basis of such time-related information, still how long it has to wait before the relevant wakeup signal will be transmitted. The tag may then go back to sleeping mode, wakeup just before the calculated time of transmission of the relevant wakeup beacon/signals, and start communication with the RFID reader transmitting the wakeup signals.

As a means of ensuring identification of an RFID tag even in case of battery failure, and according to a further aspect of this invention, an RFID tag assembly is shown in FIG. 5, and generally designated as 10, as including both an active RFID tag 12 and a passive RFID tag 14. The passive RFID tag 14 is stored with a unique identification (ID) code, such as that of the active RFID tag 12. In normal operation, the active RFID tag 12 may respond to queries transmitted by an active RFID reader. Even in case of battery failure, an operator may use a passive RFID reader to query the tag assembly 10. Although the active RFID tag 12 cannot function in case of battery failure, the minute electrical current induced in the antenna of the passive RFID tag 14 by the incoming radio frequency query signals from a passive RFID reader provides just enough power for the integrated circuit in the passive RFID tag 14 to power up and transmit a response. The passive RFID tag 14 may then transmit the unique ID code to the passive RFID reader in response to a query from it.

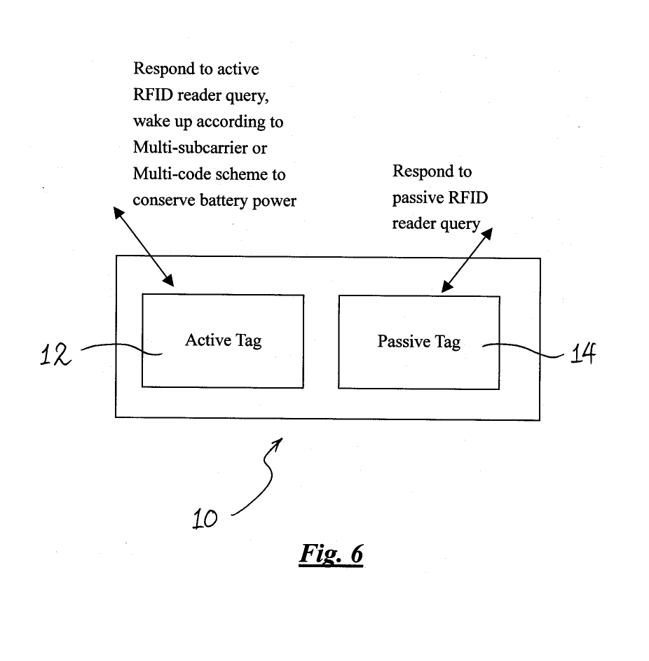

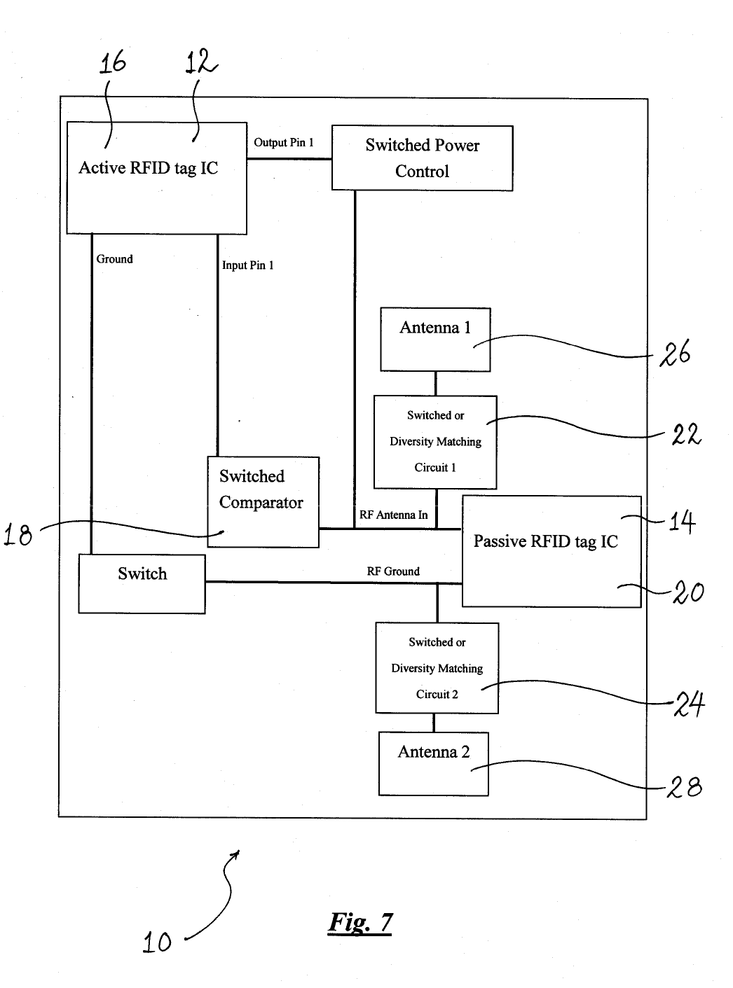

As shown in FIG. 6, the active RFID tag 12 may b software-configured to respond to and wakeup to wakeup signals with a specific characteristic, such as according to the multi-subcarrier wakeup scheme or the multi-code wake p scheme discussed above. Thus, while the passive RFID tag 14 can respond to queries from passive RFID reader (without expending any energy source in the RFID tag assembly 10), the battery life of the tag assembly 10 can be further preserved by configuring the active RFID tag 12 to only respond and wakeup to wakeup signals of a pre-determined characteristic, e.g. of a pre-determined frequency carrier or with a pre-determined code.

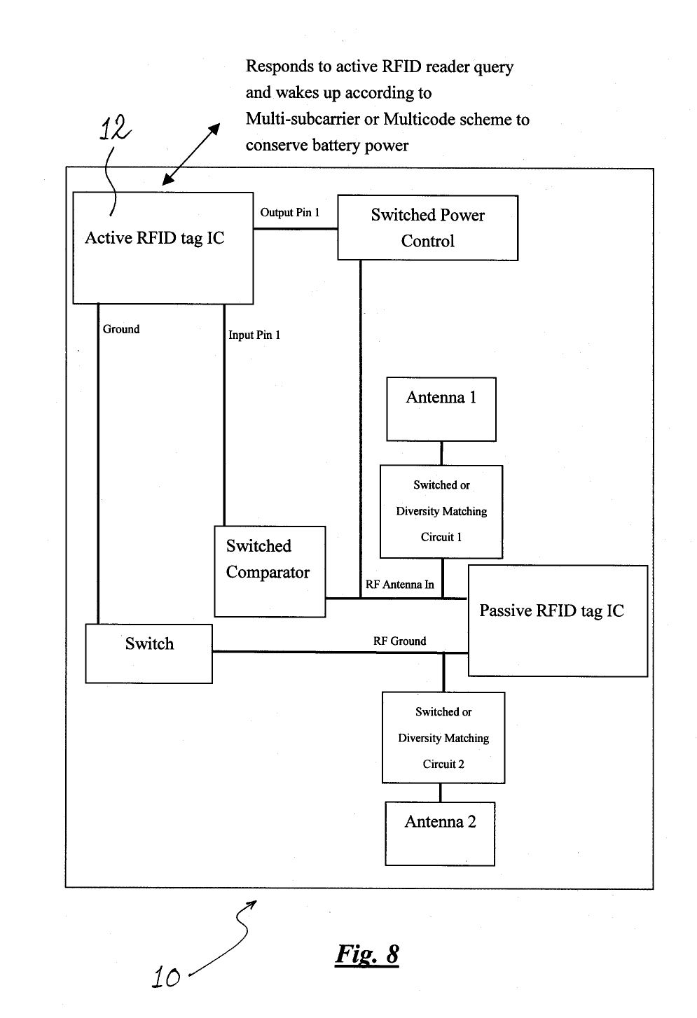

FIG. 7 shows a circuit arrangement of the RFID tag assembly 10 with the active RFID tag 12 and the passive RFID tag 14. The tag assembly 10 has an internal baseband coupling circuit to read from and write data to the radio frequency (RF) terminal of the passive RFID 14, so that critical information can be stored in a non-volatile memory of the passive RFID tag 14. Such critical information may then be read back by a passive RFID reader even in cases where there is a battery failure or the battery life has run out.

According to the circuit arrangement shown in FIG. 7, a baseband pulse from the output terminal (Output Pin 1) of an integrated circuit (IC) 16 of the active RFID tag 12 in the proper command format is directly coupled to an RF antenna terminal (RF Antenna In) of the passive RFID tag 14, and the same connector from the passive RFID tag 14 is connected to a comparator 18 and then finally to an input terminal (Input Pin 1) of the IC 16 of the active RFID tag 12. Each of the “RF Antenna In” port and “RF Ground” port of an IC 20 of the passive RFID tag 14 is separately connected to a respective matching circuit 22, 24 and then to a respective antenna 26, 28. Such an arrangement optimizes sensitivity when the tag assembly 10 is independently read by a passive RFID tag reader, while allowing the tag assembly 10 to be read by an active RFID tag reader.

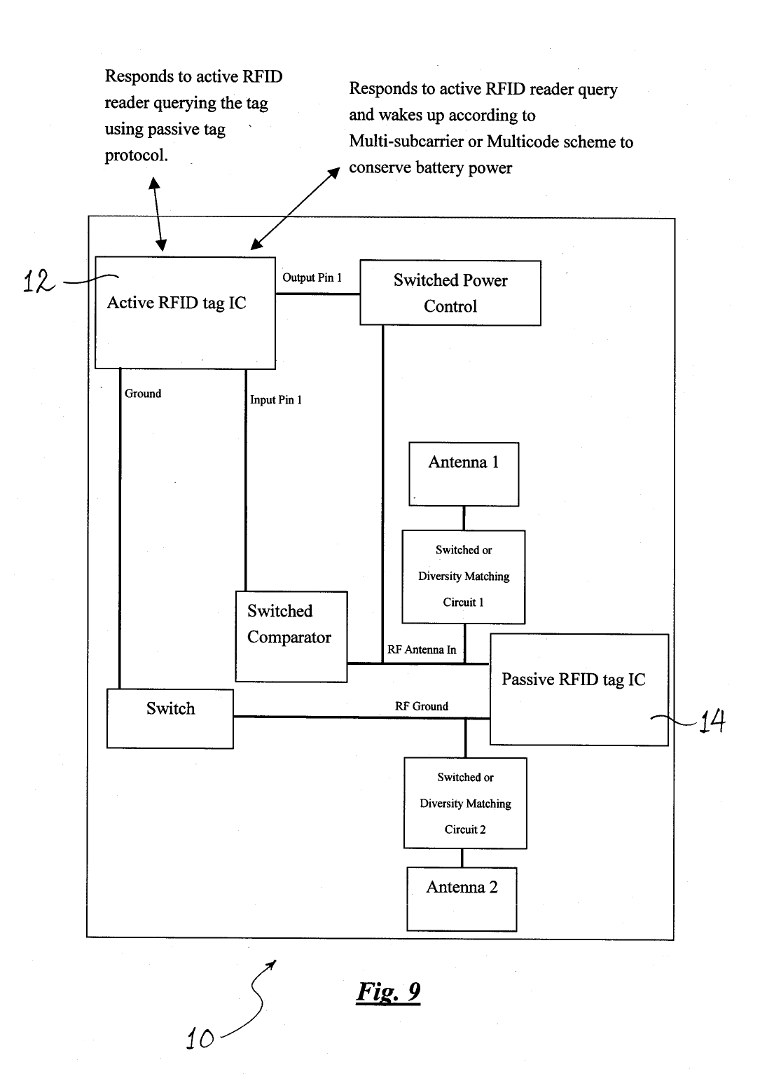

As discussed above, and as shown in FIG. 8, the active RFID tag 12 may be software-configured to respond to and wakeup to wakeup signals with a specific characteristic, such as according to the multi-subcarrier wakeup scheme or the multi-code wakeup scheme discuss above, so as to conserve battery power.

As a further alternative to this arrangement, and as shown in FIG. 9, the active RFID tag 12 may be one with passive RFID tag protocol responding capability, so that it can respond to both short-range backscatter mode passive RFID protocol reader and long-range 2-way communication mode passive RFID protocol reader. As the data (in particular critical data) can be stored in and transferred between the active RFID tag 12 and the passive RFID tag 14 (as discussed above), the stored data can be transferred among all three modes of RFID operation, namely active RFID reader, 2-way communication mode passive RFID reader, and traditional backscatter mode passive RFID reader. This is therefore a triple connectivity tag.

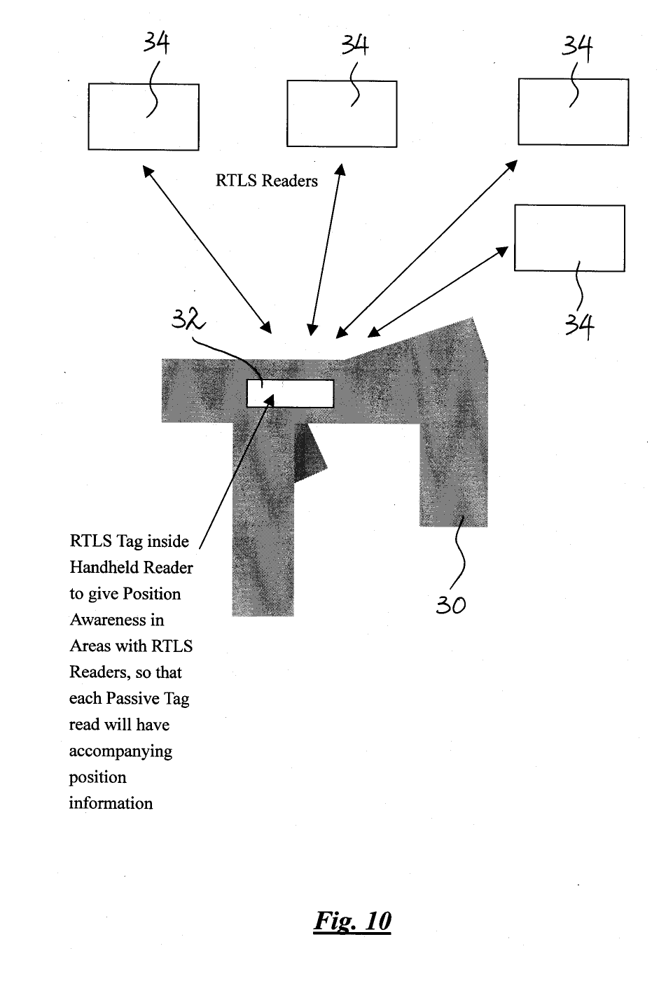

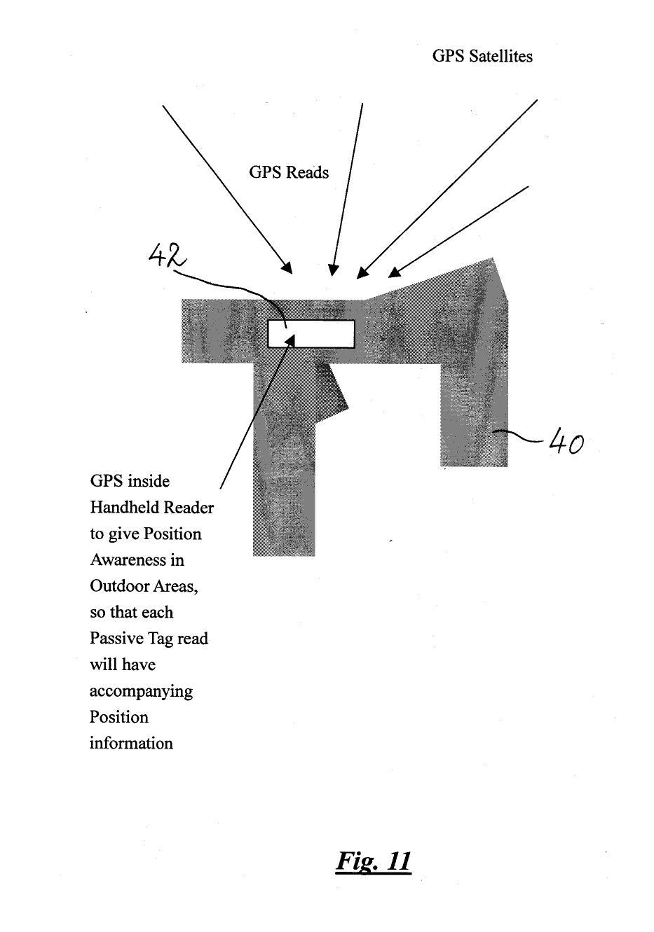

To further enhance the function of the existing RFID system, a handheld/portable RFID reader is shown in FIG. 10 and generally designated as 30. The portable RFID reader 30 contains a real time location tracking (RTLS) RFID tag 32 so that the exact location (for example as represented in an x, y, z, location on earth) of the reader 30 can be ascertained by neighboring RTLS readers 34, whether indoor or outdoor. Thus all read/write operations carried out by the reader 30 will have a x, y, z, location on earth as a position reference, and clock information obtained from a network clock server with which the reader 30 is associated, as a time reference. The reader 30 will thus have both an absolute spatial reference and absolute temporal reference for each of its read/write operation, even if the reader 30 may be a passive RFID reader for obtaining responses from passive RFID tags.

As an alternative, a handheld/portable RFID reader shown in FIG. 11 and generally designated as 40 may include a global positioning system (GPS) receiver 42 for receiving position signals from GPS satellites, so that the exact location or the reader 40 is known outdoor and to some extent, indoor. Thus, all read/write operations carried out by the reader 40 will have a x, y, z location on earth as a position reference, and clock information obtained from a network clock server, as a time reference. The reader 40 will thus have both an absolute spatial reference and an absolute temporal reference for each of its read/write operations, even if the reader 40 may be a passive RFID reader for obtaining responses from passive RFID tags.

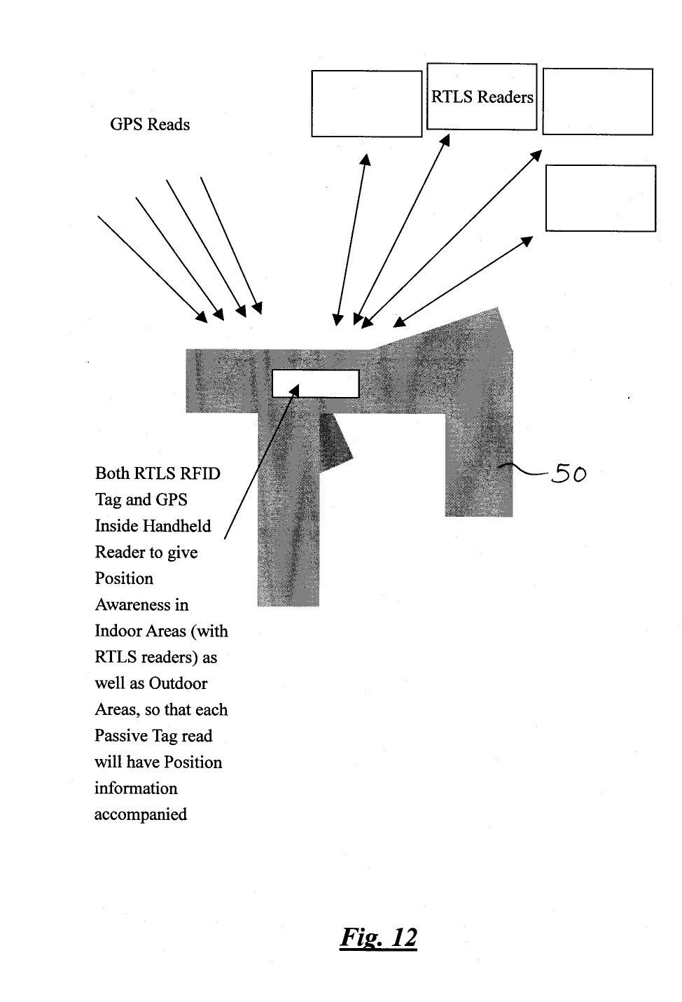

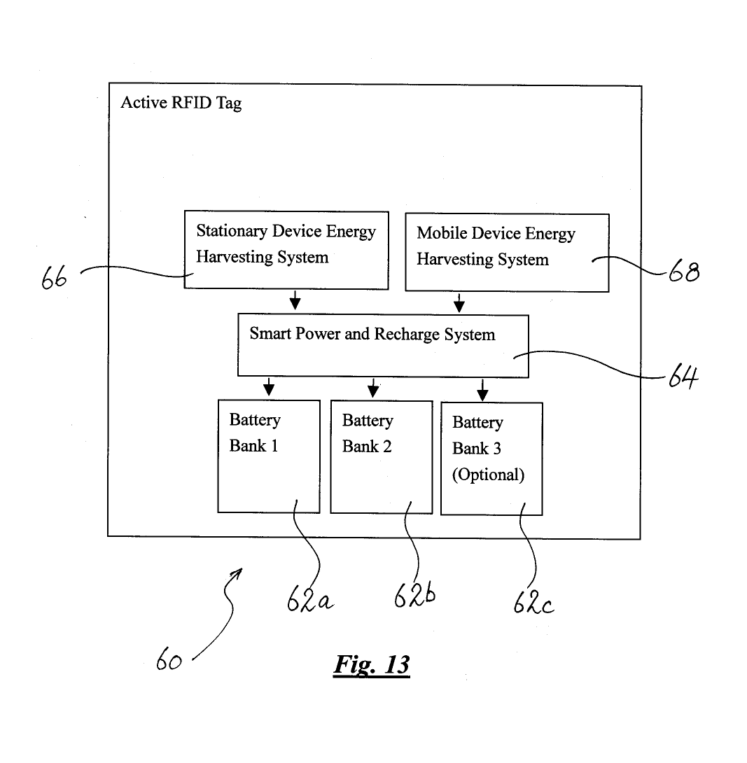

To provide a higher degree of redundant absolute positional reference and time reference that will enable location tracking both indoor and outdoor (even in outdoor areas with no neighboring RTLS readers), and as shown in FIG. 12, a handheld/portable RFID reader generally designated as 50 includes both an RTLS RFID tag and a GPS receiver, which provide it with both an absolute spatial reference and an absolute temporal reference for each of its read/write operations, even if the reader 50 may be a passive RFID reader for obtaining responses from passive RFID tags, and even if with no RTLS readers in the vicinity.

An active RFID tag according to a still further aspect of the present invention is shown in FIG. 13 and generally designated as 60. With a view to prolonging the usable life of the tag 60, the tag 60 includes a number of rechargeable electric batteries 62a, 62b, 62c, a smart power and recharge system 64, and energy harvesting means, here being represented as both a stationary device energy harvesting system 66 and a mobile device energy harvesting system 68. Generally speaking, an energy harvesting system captures and stores energy. The stationary device energy harvesting system 66 and the mobile device energy harvesting system 68 may be a solar cell, piezoelectric cell, thermoelectric cell, or kinetic power harvesting device. The recharge system 64 will recharge the batteries not currently in use. For example, if the battery 62a is being used, the recharge system 64 will recharge the batteries 62b and/or 62c with the electrical energy harvested by the energy harvesting systems 66, 68.

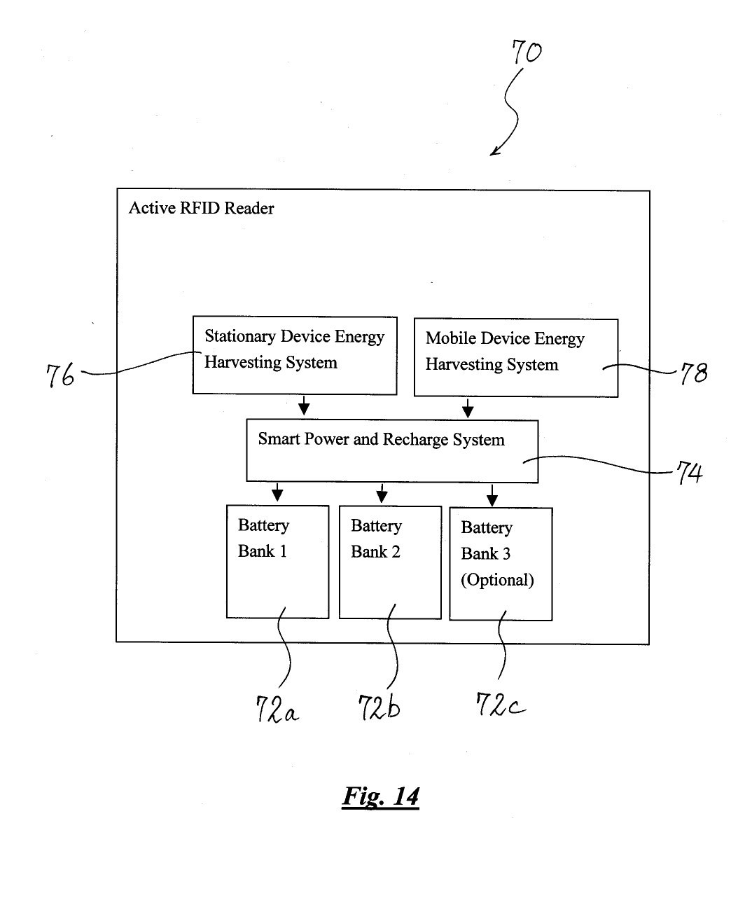

Adopting the same basic principle, an active RFID reader generally designated as 70 and shown in FIG. 14 includes a number of rechargeable electric batteries 72a, 72b, 72c, a smart power and recharge system 74, and energy harvesting means, here including both a stationary device energy harvesting system 76 and a mobile device energy harvesting system 78. The stationary device energy harvesting system 76 and the mobile device energy harvesting system 78 may be a solar cell, piezoelectric cell, thermoelectric cell, or kinetic power harvesting device. The recharge system 74 will recharge the batteries not current in use. For example, if the battery 72a is being used, the recharge system 74 will recharge the batteries 72b and/or 72c with the electrical energy harvested by the energy harvesting systems 76, 78.

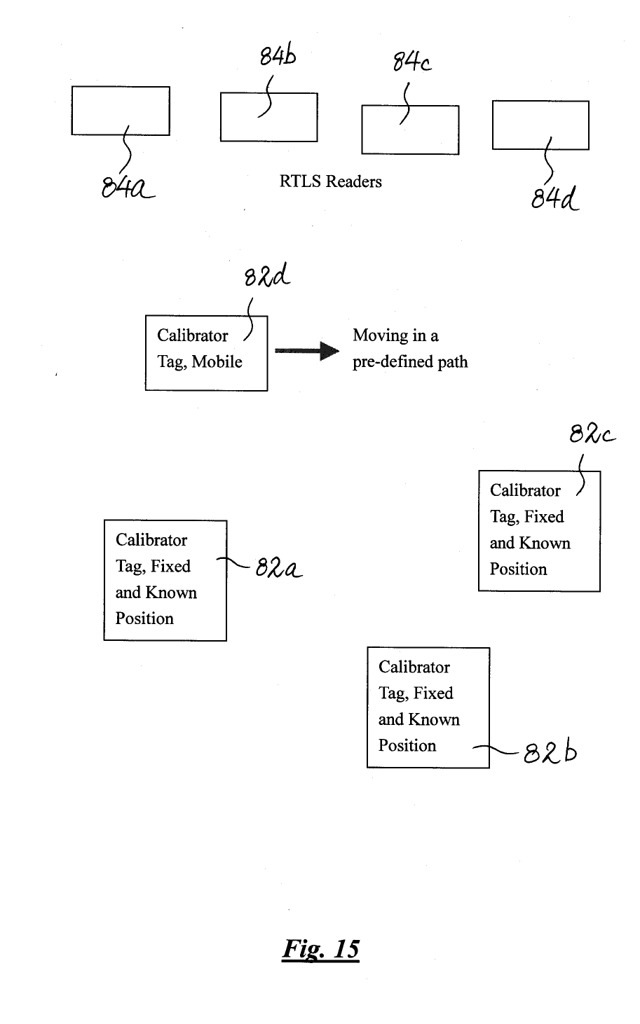

FIG. 15 shows an arrangement of a method for calibrating a number of RTLS RFID readers in an environment, for locating RFID tags in the environment. Calibrator Tags 82a, 82b, 82c are each positioned in a fixed and known position in the environment. RTLS RFID readers 84a, 84b, 84c, 84d to be calibrated are placed in the environment. A movable Calibrator Tag 82d is moved, during the calibration process, along a pre-determined path in the environment, such that the position of the Calibrator Tag 82d at any point of time during the calibration process is also pre-determined.

The movable Calibrator Tag 82d should be fixedly associated with an optical barcode, optical descriptor or a passive RFID tag for simultaneous movement. Each of the fixed calibrating positions occupied by the Calibrator Tags 82a, 82b, 82c should have a landing pattern to allow the calibrator, with a camera, to allow optical alignment.

A data processing apparatus (e.g. a so called “location engine”) associated with the four RTLS RFID readers 84a, 84b, 84c, 84d may then obtain readings of location-related information relating to the various Calibrator Tags 82a, 82b, 82c, 82d as obtained by each of the four RTLS RFID readers 84a, 84b, 84c, 84d at a same point of time. The location engine then compares such readings with the actual known positions of the Calibrator Tags 82a, 82b, 82c, 82d at that point of time, so as to assess the ranging performance of each of the RTLS RFID readers 84a, 84b, 84c, 84d. The location engine may then decide whether to use or discard ranging information from one or more of the RTLS RFID readers 84a, 84b, 84c, 84d, or whether to assign different weights on the readings from different RTLS RFID readers 84a, 84b, 84c, 84d.

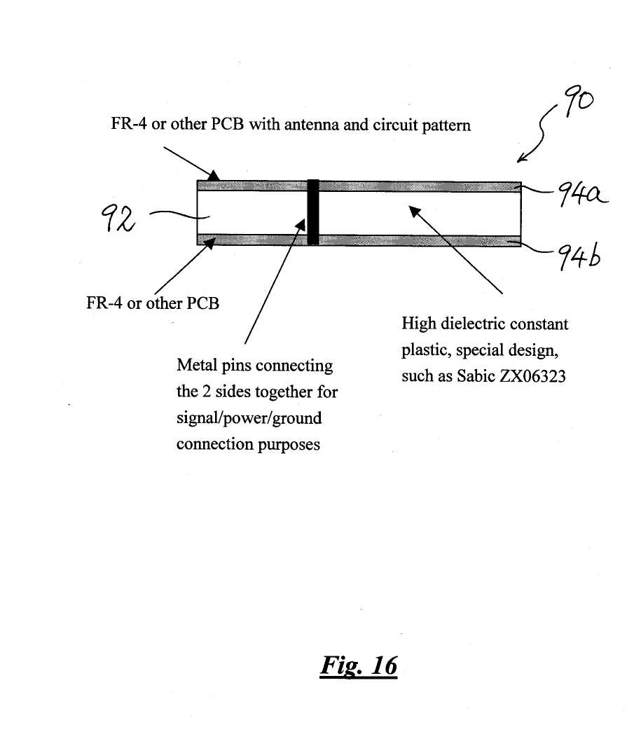

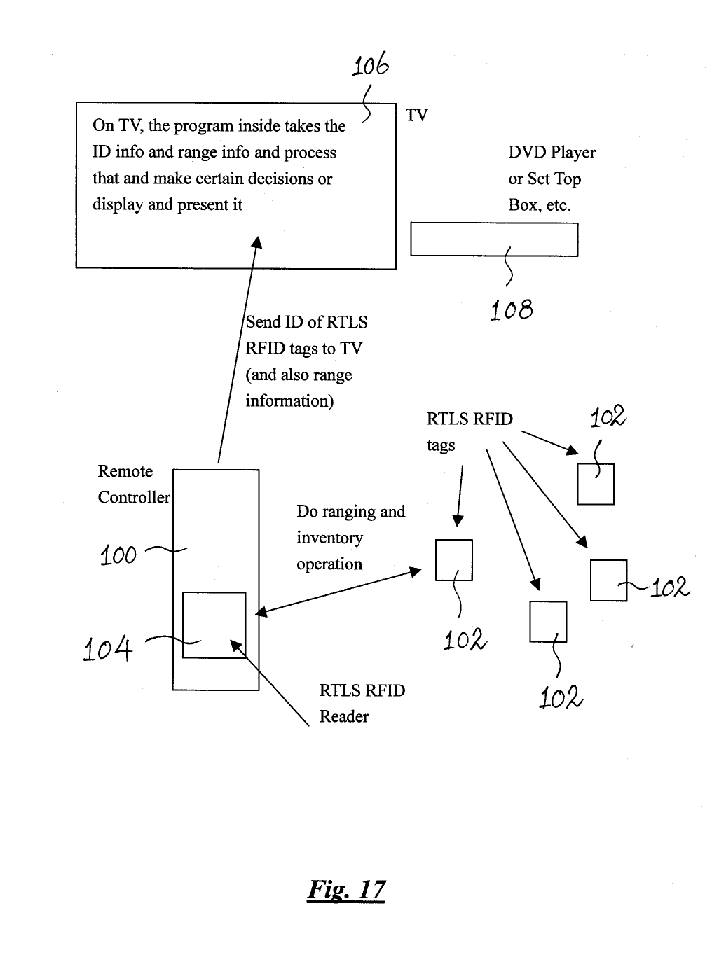

An RFID tag and reader antenna or integrated reader circuit may be fabricated by a new method as schematically shown in FIG. 16. The RFID tag, generally shown as 90 in FIG. 16, is formed of an inner slab 92 of a high dielectric constant plastic material with upper and lower major surfaces. In particular, the slab 92 of plastic material is of a dielectric constant of at least 6.5. The high dielectric constant plastic material may be one traded by Saudi Basic Industries Corp. under Model No. Sabic Innovative Plastics™ ZX06323 or RX06324. Onto each of the major surfaces of the slab 92 is fixedly secured (e.g. by lamination) an outer single- or multi-layered material 94a, 94b suitable for fabricating a printed circuit board (PCB). An appropriate material is one called “FR-4”. FR-4 is an abbreviation for “Flame Retardant 4”. It is a composite of a resin epoxy reinforced with a woven fiberglass mat, and is a material from the class of epoxy resin bonded glass fabric. Metal pins (of which only one, designated as 96, is shown in FIG. 16) are provided to electrically connect the two layers of PCB material 94a, 94b, for signal/power/ground connection purposes. An antenna may be formed on the outer surface of the layer of PCB material 94a, while allowing circuitry to form, thus creating an all-in-one tag and antenna assembly. When assembled, an integrated circuit (IC) is also provided to be in electrical connection with the antenna, to form an RFID tag.

The same technique can be used for the formation of an RF antenna arrangement of an RFID reader, i.e. an RFID reader may also include, for its RF antenna arrangement, an inner high dielectric constant plastic layer with two major surfaces, two outer layers of PCB materials (e.g. FR-4) laminated each on a respective major surface of the inner plastic layer, with an antenna formed on the outer surface of one of the two outer PCB material layers. Metal pins are provided to electrically connect the two layers of PCB material for signal/power/ground connection purposes.

In an RFID system according to a yet further aspect of the present invention, and as shown in FIG. 17, a remote controller 100 is in a data communicable relationship, on a first hand, with a number of RTLS RFID tags 102 and, on a second hand, with a data processing apparatus, which is associated with an electrical appliance, e.g. a television set 106, a DVD player 108, a blu-ray player, a high-definition (HD) DVD player, a digital media player, a set top box, or a personal computer (PC). The remote controller 100 contains an active RTLS RFID reader 104. The RTLS RFID tags 102 may be tagged on assets, people, pets or vehicles.

In use, the RTLS RFID reader 104 in the remote controller 100 can wirelessly obtain data relating to the RTLS RFID tags 102 (such as their respective unique ID, range, etc.) and transmit such data wirelessly to the data processing apparatus. Upon reception and possible further manipulation of the data (upon execution of a computer program in the data processing apparatus), the data processing apparatus transmits such (manipulated) data to a visual display unit (e.g. the television set 106, or the monitor of the PC) for visual display. Such data may be displayed as text information or in the form of a radial map showing distances of the tags 102 (and thus the tagged items) with respect to the remote controller 100 (which contains the RFID reader 104). The tag ID information and range information as obtained by the RFID reader 104 of the controller 100 and transmitted to the data processing apparatus may be used for other purposes.

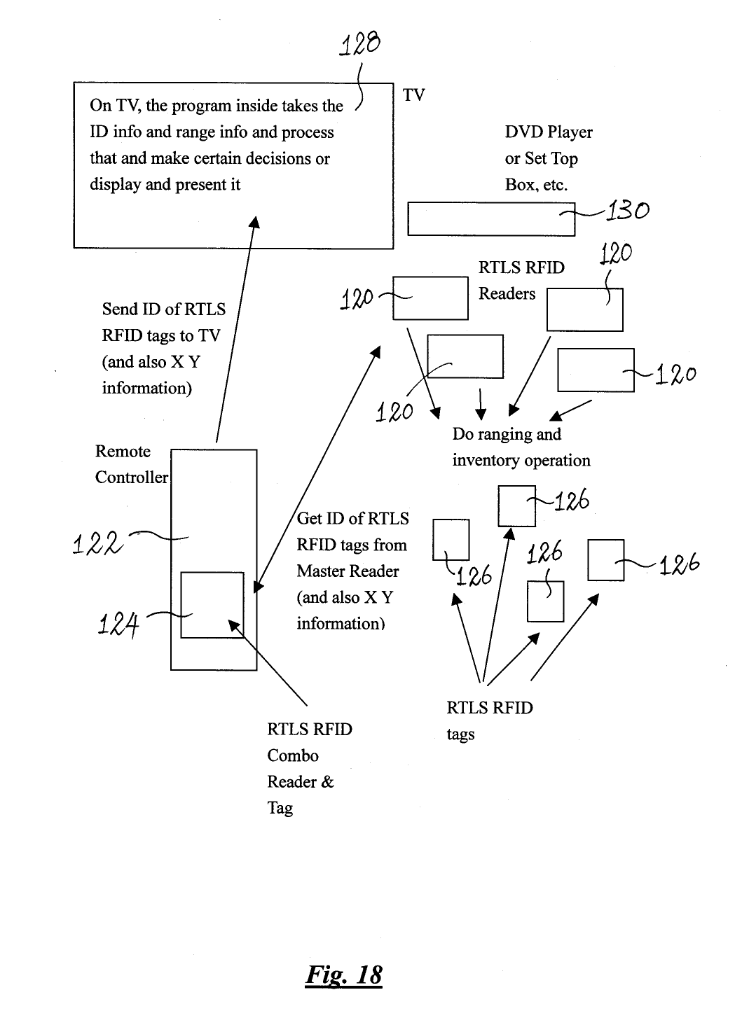

As an alternative arrangement, and as shown in FIG. 18, an RFID system includes a number of RTLS RFID readers 120 positioned in strategic positions in an environment (e.g. a house), and a remote controller 122 including an RTLS RFID reader or tag 124 which can communicate with the RTLS RFID readers 120 to initiate an inventory and/or ranging query on a number of RTLS RFID tags 126. Data obtained by the RTLS RFID readers 120 are transmitted to the RTLS RFID reader or tag 124 of the remote controller 122, and then subsequently transmitted wirelessly by the remote controller 122 to a data processing apparatus (not shown) of an electrical appliance (e.g. a television set 128, a DVD player 130 or set top box), for subsequent visual display by a visual display unit.

As a number of RFID readers 120 are used, multiple range information relating to a same RFID tag 126 may be obtained. It is possible to obtain the x, y coordinates of the tag 126 by triangulation. The x, y location of the tag 126 may then be shown on the visual display unit with an x, y coordinated map.

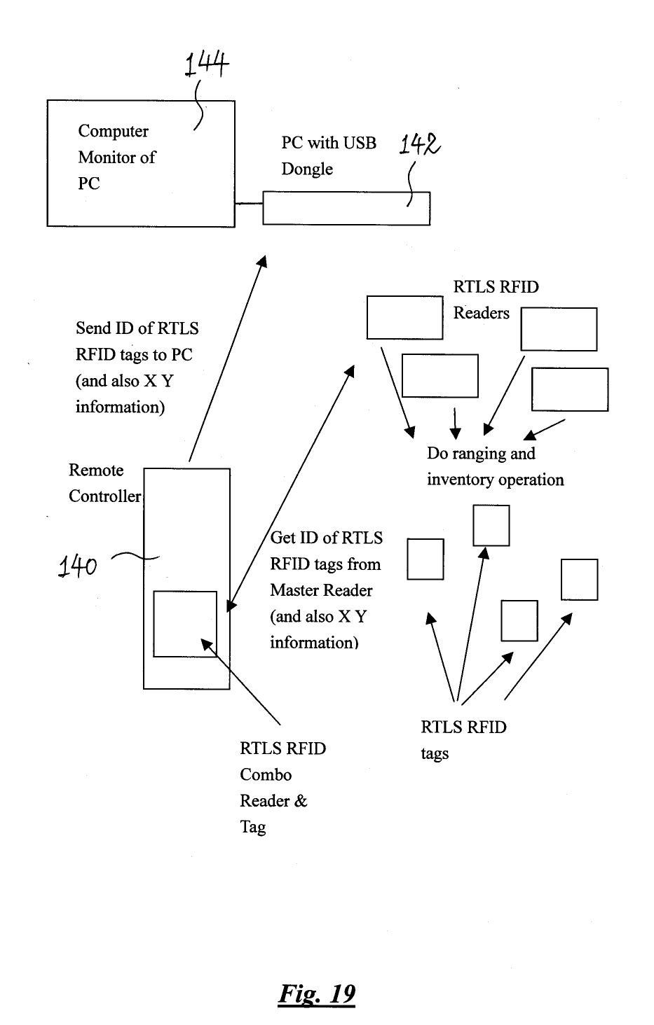

As a further alternative RFID system, and as shown in FIG. 19, a remote controller 140 transmits information to a personal computer (PC) 142 via a wireless USB dongle or bridge. A dongle is a small hardware device that connects to a computer, often to authenticate a piece of software. When the dongle is not present, the software runs in a restricted mode or refuses to run. The data are then transmitted to a computer monitor 144 for visual display. The information may likewise be text based, on a radial map, or on an x, y coordinated map.

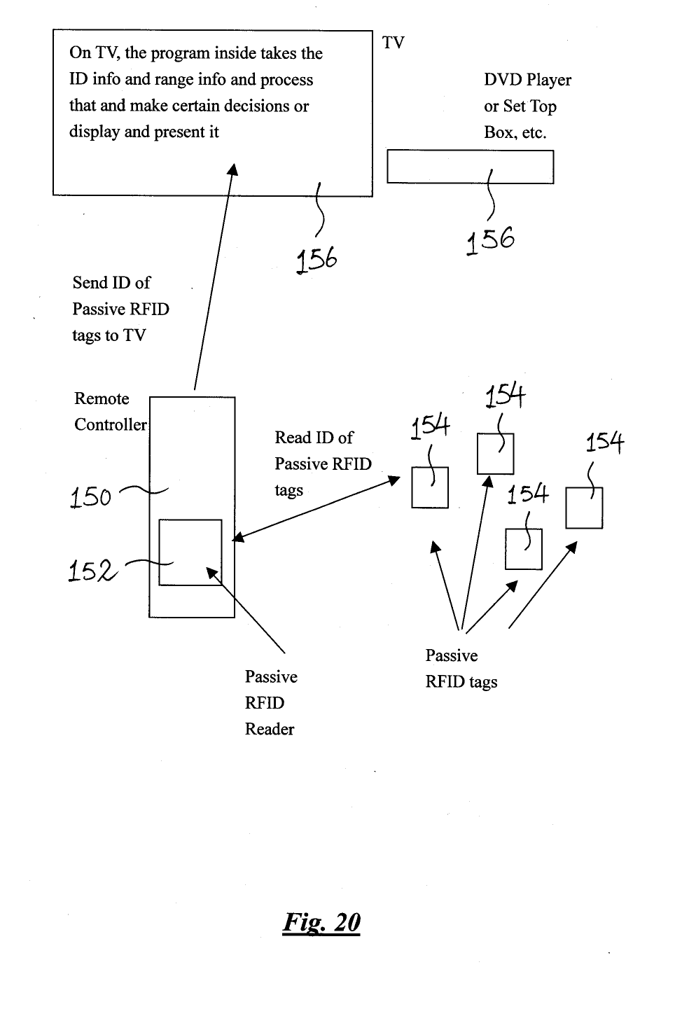

As a yet further alternative RFID system, and as shown in FIG. 20, a remote controller 150 includes a passive RFID reader 152 which reads identity (ID) data from a number of passive RFID tags 154. As in the previous RFID systems, data obtained by the remote controller 150 are transmitted to a data processing apparatus of an electrical appliance 156 for display on a visual display unit.

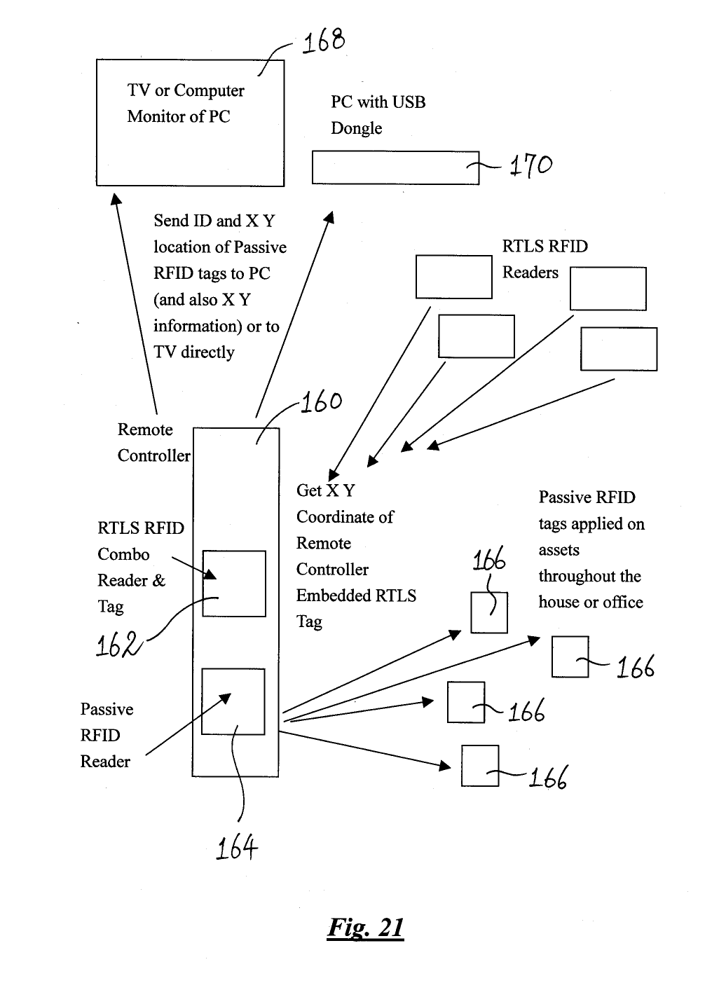

As a still further alternative RFID system, and as shown in FIG. 21, a remote controller 160 includes both an RTLS reader or tag 162 and a passive RFID reader 164. By way of such an arrangement, it is possible to go around the house with the remote controller 160 and read passive RFID tags 166 tagged on all kinds of assets. The RTLS reader/tag 162 in the remote controller 160 will give the x, y (and maybe even z) coordinates of the tags 166. Such information is then sent either to a memory in an electrical appliance (e.g. a television set 168) for storage, or to a personal computer 170 for storage. Such data may later be displayed on the television set 168 or a monitor of the personal computer 170.

It should be understood that the above only illustrates examples whereby the present invention may be carried out, and that various modifications and/or alterations may be made thereto without departing from the spirit of the invention.

It should also be understood that certain features of the invention, which are, for clarity, described in the context of separate embodiments, may be provided in combination in a single embodiment. Conversely, various features of the invention which are, for brevity, described in the context of a single embodiment, may also be provided separately or in any appropriate sub-combinations.

1. A method of selectively waking up at least two RFID tags, including the steps of:
(a) providing a first RFID tag;
(b) programming said first RFID tag to respond to and wake up only to signals with a first characteristic;
(c) providing a second RFID tag; and
(d) programming said second RFID tag to respond to and wake up to only to signals with a second characteristic.

2. A method according to claim 1 further including a step (e) of transmitting signals with said first characteristic to wake up said first RFID tag.

3. A method according to claim 1 further including a step (f) of transmitting signals with said second characteristic to wake up said second RFID tag.

4. A method according to claim 1 wherein said first characteristic and said second characteristic are two different frequency subcarriers.

5. A method according to claim 1 wherein said first characteristic and said second characteristic are two different codes.

6. A method according to claim 1 further including a step (g) of re-programming said first RFID tag to respond to and wake up only to signals with a characteristic different to said first characteristic when said first RFID tag moves from a first zone to a second zone.

7. A method according to claim 1 wherein in said step (a), said first RFID tag is programmed to respond to and wake up only to signals with said first characteristic for a first pre-determined period of time.

8. A method according to claim 7 wherein in said step (a), said first RFID tag is programmed to respond to and wake up only to signals with a characteristic different to said first characteristic after expiration of said first pre-determined period of time.

9. A method according to claim 8 wherein said first RFID tag is adapted to respond to and wake up only to signals with said different characteristic for a second pre-determined period of time.

10. A dual-mode active RFID tag, wherein said tag is adapted to be in a real time location system (RTLS) mode for a first pre-determined period of time and in an inventory mode for a second pre-determined period of time.

11. An RFID tag according to claim 10 wherein when in said RTLS mode, said tag is adapted to provide real time information on its position when queried.

12. An RFID tag according to claim 10 wherein when in said inventory mode, said tag is adapted only to provide identity information when queried.

13. An RFID tag according to claim 10 wherein said tag is adapted to alternate between said RTLS mode and inventory mode.

14. A signal transmission apparatus for transmitting wakeup signals to RFID tags, said apparatus being adapted to transmit signals with information indicative of the cumulative period of time which has lapsed since transmission of the first wakeup signal.

15. An apparatus according to claim 14 wherein said signals include time slots with time index.

16. A method of transmitting wakeup signals to RFID tags, including transmitting signals with information indicative of the cumulative period of time which has lapsed since transmission of the first wakeup signal.

17. A method according to claim 16 wherein said signals include time slots with time index.

18. An RFID tag assembly with at least an active RFID tag and at least a passive RFID tag.

19. An RFID tag assembly according to claim 18 wherein said passive tag module is stored with a unique identity (ID) code.

20. An RFID tag assembly according to claim 18 wherein said active tag module is adapted to respond to and wake up only to signals of a first characteristic.

21. An RFID tag assembly according to claim 18 further including means adapted to read data from and write data to a radio-frequency (RF) terminal of said passive tag module.

22. An RFID tag assembly according to claim 21 wherein said reading/writing means is a baseband coupling circuit.

23. An RFID tag assembly according to claim 18 wherein said active tag module is of passive RFID tag protocol responding capability.

24. A portable RFID reader containing a real time location tracking RFID tag.

25. An RFID reader according to claim 24 wherein said reader is adapted to provide spatial location reference of each reading and/or writing operation.

26. An RFID reader according to claim 24 wherein said reader is adapted to provide time information of each reading and/or writing operation.

27. An RFID reader according to claim 26 wherein said reader is adapted to obtain time information from a network clock server.

28. A portable RFID reader containing a global positioning system (GPS) receiver.

29. An RFID reader according to claim 28 wherein said reader is adapted to provide time information of each reading and/or writing operation.

30. An RFID reader according to claim 28 wherein said reader is adapted to obtain time information from a network clock server.

31. An active RFID tag with at least two electric power sources, wherein at least one of said electric power sources is rechargeable.

32. An active RFID tag according to claim 31 wherein said electric power sources are electric batteries.

33. An active RFID tag according to claim 31 further including means for recharging said rechargeable electric power source.

34. An active RFID tag according to claim 33 wherein said recharging means is a stationary energy harvesting device or a mobile energy harvesting device.

35. An active RFID tag according to claim 33 wherein said recharging means is a solar cell, kinetic energy harvesting means, piezoelectric cell, or thermoelectric cell.

36. An active RFID tag according to claim 31 further including at least two rechargeable electric sources, wherein said recharging means is adapted to recharge at least one of said rechargeable electric source which is not current in use.

37. An active RFID tag reader with at least two electric power sources, wherein at least one of said electric power sources is rechargeable.

38. An active RFID tag reader according to claim 37 wherein said electric power sources are electric batteries

39. An active RFID tag reader according to claim 37 further including means for recharging said rechargeable electric power source.

40. An active RFID tag reader according to claim 39 wherein said recharging means is a stationary energy harvesting device or a mobile energy harvesting device.

41. An active RFID tag reader according to claim 39 wherein said recharging means is a solar cell, mechanical watch movement with generator, piezoelectric charging means, or thermoelectric charging means.

42. An active RFID tag reader according to claim 37 further including at least two rechargeable electric sources, and wherein said recharging means is adapted to recharge at least one of said rechargeable electric source which is not current in use.

43. A method of calibrating an RFID tag positioning system with at least a first and a second real time location tracking active RFID readers, including the steps of:
(a) positioning said at least two real time location tracking active RFID readers in two respective locations in an environment;
(b) positioning a first calibrating RFID tag at a fixed and known position in said environment;
(c) moving a second calibrating RFID tag along a pre-determined path in said environment;
(d) obtaining said first RFID reader's readings of location-related information of said first and second calibrating RFID tags at a point in time;
(e) obtaining said second RFID reader's readings of location-related information of said first and second calibrating RFID tags at said point in time; and
(f) comparing said readings of said first RFID reader and of said second RFID reader with said known positions of said first and second calibrating tags.

44. A method according to claim 43 further including a step (g) of disregarding readings from at least one of said active RFID readers.

45. A method according to claim 43 further including a step (h) of assigning different weights to said readings from said at least two active RFID readers when determining the location of an RFID tag.

46. A method according to claim 43 wherein said second calibrating RFID tag is fixedly associated with an optical barcode or an optical descriptor.

47. A method according to claim 43 wherein said second calibrating RFID tag is a passive RFID tag.

48. A method according to claim 43 wherein said fixed and known position occupied by said first calibrating RFID tag is fixedly associated with a landing pattern.

49. An RFID tag including:
an RFID tag integrated circuit;
a high dielectric constant plastic layer with two major surfaces;
a first layer of printed-circuit-board material fixedly secured on a first major surface of said plastic layer;
a second layer of printed-circuit-board material fixedly secured on a second major surface of said plastic layer; and
an antenna formed on said first layer of printed-circuit-board material.

50. An RFID tag according to claim 49 further including at least one metal pin electrically connecting said first and second layers of printed-circuit-board material.

51. An RFID reader including:
a high dielectric constant plastic layer with two major surfaces;
a first layer of printed-circuit-board material fixedly secured on a first major surface of said plastic layer;
a second layer of printed-circuit-board material fixedly secured on a second major surface of said plastic layer; and
an antenna formed on said first layer of printed-circuit-board material.

52. An RFID reader according to claim 51 further including at least one metal pin electrically connecting said first and second layers of printed-circuit-board material.

53. An RFID system including:
a remote controller of an electrical appliance, said remote controller having at least one RFID reader adapted to receive at least identity (ID) data from at least one RFID tag;
a data processing apparatus adapted to receive at least said ID data from said remote controller; and
a visual display unit adapted to visually show at least said ID data of said RFID tag.

54. A system according to claim 53 wherein said remote controller is adapted to receive ranging information of said RFID tag.

55. A system according to claim 54 wherein said data processing apparatus is adapted to receive said ranging information of said RFID tag from said remote controller.

56. A system according to claim 54 wherein said visual display unit is adapted to visually display said ranging information.

57. A system according to claim 53 wherein said electrical appliance is a television set, a DVD player, a blu-ray player, a high definition (HD) DVD player, a digital media player, or a set top box.

58. A system according to claim 53 further including a plurality of RFID readers adapted to obtain data from said RFID tag and to transmit said data to said remote controller.

59. A system according to claim 58 wherein said RFID readers are adapted to determine the location of said RFID tag and to transmit data of said determined location to said remote controller.

60. A system according to claim 58 wherein said remote controller is adapted to transmit said data of said determined location of said RFID to said data processing apparatus.

61. A system according to claim 60 wherein said visual display unit is adapted to visually display said determined location of said RFID.

62. A system according to claim 53 wherein said data processing apparatus is adapted to receive said ID data from said remote controller via a USB dongle or bridge.

63. A system according to claim 53 wherein said at least one RFID reader is a passive RFID reader.

64. A system according to claim 53 wherein said at least one RFID reader is a real time location tracking (RTLS) RFID reader.

65. A system according to claim 53 wherein said remote controller includes at least one RTLS RFID reader and at least one passive RFID reader.
